(19) United States
(12) Patent Application Publication
(10) Pub. No.: US 2026/0057173 A1
(43) Pub. Date: Feb. 26, 2026

(54) INFORMATION PROCESSING METHOD, INFORMATION PROCESSING SYSTEM, AND RECORDING MEDIUM

(71) Applicant: Panasonic Intellectual Property Management Co., Ltd., Osaka (JP)

(72) Inventors: Kotaro SAKATA, Osaka (JP); Tetsuji FUCHIKAMI, Osaka (JP)

(21) Appl. No.: 19/379,075

(22) Filed: Nov. 4, 2025

Related U.S. Application Data
(63) Continuation of application No. PCT/JP2024/007681, filed on Mar. 1, 2024.

(30) Foreign Application Priority Data
May 19, 2023 (JP) 2023-083386

(51) Int. Cl. G06F 40/268

(52) U.S. Cl. CPC G06F 40/268

(57) ABSTRACT

An information processing method includes: obtaining, as text information, information related to communication by a person; performing emotion analysis on a plurality of words or phrases after breaking down the text information into the plurality of words or phrases by performing morphological analysis on the text information; and visualizing an analysis result of the emotion analysis according to each row and column of a matrix table by forming the matrix table by arranging, in a first direction, a plurality of emotional expression-related items that represent human emotions and arranging, in a second direction, an attribute category-related item that indicates an attribute of the person or an organization.

### CROSS REFERENCE TO RELATED APPLICATIONS

This is a continuation application of PCT International Application No. PCT/JP2024/007681 filed on March 1, 2024, designating the United States of America, which is based on and claims priority of Japanese Patent Application No. 2023-083386 filed on May 19, 2023. The entire disclosures of the above-identified applications, including the specifications, drawings and claims are incorporated herein by reference in their entirety.

### FIELD

The present disclosure relates to an information processing method, an information processing system, and a recording medium.

### BACKGROUND

Patent Literature (PTL) 1 discloses an organizational communication visualization system that analyzes a state of an organization, a state of a sub-organization, and a state of individuals, based on face-to-face communication between persons belonging to the organization. The visualization system includes a plurality of terminals and a processing device that processes data transmitted from the plurality of terminals, and each of the plurality of terminals includes a sensor that detects a physical quantity and a data transmitter that transmits data indicating the physical quantity detected by the sensor. The processing device of the visualization system visualizes organizational communication by plotting data transmitted from a first terminal on a coordinate plane in which the vertical axis indicates an amount of communication and the horizontal axis indicates diversity of communication.

### Citation List

### Patent Literature

PTL 1: Japanese Unexamined Patent Application Publication No. 2013-257896

### SUMMARY

### Technical Problem

However, even when organizational communication is visualized based on an amount of communication and diversity of communication as disclosed in PTL 1, the emotion of a person belonging to the organization during communication cannot be visualized.

An information processing method or the like according to the present disclosure visualizes the emotion of a person belonging to an organization during communication.

### Solution to Problem

An information processing method according to an aspect of the present disclosure is an information processing method that is performed by a computer and includes: obtaining, as text information, information related to communication by a person; performing emotion analysis on a plurality of words or phrases after breaking down the text information into the plurality of words or phrases by performing morphological analysis on the text information; and visualizing an analysis result of the emotion analysis according to each row and column of a matrix table by forming the matrix table by arranging, in a first direction, a plurality of emotional expression-related items that represent human emotions and arranging, in a second direction, an attribute category-related item that indicates an attribute of the person or an organization.

An information processing system according to an aspect of the present disclosure includes: an information obtainer that obtains, as text information, information related to communication by a person; an emotion analyzer that performs emotion analysis on a plurality of words or phrases after breaking down the text information into the plurality of words or phrases by performing morphological analysis on the text information; and an emotion visualizer that visualizes an analysis result of the emotion analysis according to each row and column of a matrix table by forming the matrix table by arranging, in a first direction, a plurality of emotional expression-related items that represent human emotions and arranging, in a second direction, an attribute category-related item that indicates an attribute of the person or an organization.

A recording medium according to an aspect of the present disclosure is a non-transitory computer-readable recording medium having recorded thereon a program for causing a computer to execute the above-described information processing method.

### Advantageous Effects

An information processing method or the like according to an aspect of the present disclosure can visualize the emotion of a person belonging to an organization during communication.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating an information processing system according to an embodiment.

FIG. 2 illustrates a block configuration of the information processing system according to the embodiment and an information processing device included in the information processing system.

FIG. 3 illustrates an overview of processes performed by the information processing system.

FIG. 4 illustrates an example of emotion analysis performed by the information processing device.

FIG. 5 illustrates an example of a matrix table used for visualizing emotional expressions.

FIG. 6 illustrates another example of the matrix table.

FIG. 7 is a flowchart illustrating an information processing method according to the embodiment.

### DESCRIPTION OF EMBODIMENT

An information processing method or the like according to the present disclosure includes the processes described below for visualizing the emotion of a person belonging to an organization during communication.

An information processing method according to Example 1 is an information processing method that is performed by a computer and includes: obtaining, as text information, information related to communication by a person; performing emotion analysis on a plurality of words or phrases after breaking down the text information into the plurality of words or phrases by performing morphological analysis on the text information; and visualizing an analysis result of the emotion analysis according to each row and column of a matrix table by forming the matrix table by arranging, in a first direction, a plurality of emotional expression-related items that represent human emotions and arranging, in a second direction, an attribute category-related item that indicates an attribute of the person or an organization.

Thus, the emotion of a person belonging to an organization during communication can be visualized by visualizing an analysis result of emotion analysis according to each row and column of a matrix table that is formed by emotional expression-related items and an attribute category-related item.

An information processing method according to Example 2 is the information processing method according to Example 1, wherein in the visualizing of the analysis result, at least one of the following may be visualized as the analysis result: a word or phrase that has a high appearance frequency among the plurality of words or phrases in the text information; or frequency information that indicates appearance frequency levels of the plurality of words or phrases in the text information.

For example, by visualizing a word or phrase that has a high appearance frequency among a plurality of words or phrases in text information, it is possible to visualize which emotion a person belonging to an organization has expressed with which word or phrase during communication. Moreover, for example, by visualizing frequency information that indicates appearance frequency levels of a plurality of words or phrases in text information, the emotion of a person belonging to an organization during communication can be visualized so that the emotion can be understood immediately.

An information processing method according to Example 3 is the information processing method according to Example 1 or 2, wherein the attribute category-related item may be an item that is related to a group to which the person belongs or an item that is related to a job position or employment type of the person.

Accordingly, the emotion of a person during communication can be visualized in terms of an attribute category that is a group to which the person belongs or a job position or employment type of the person.

An information processing method according to Example 4 is the information processing method according to any one of Examples 1 to 3, wherein the plurality of emotional expression-related items may include delight, anger, sadness, and joy.

Accordingly, the emotion of a person during communication can be visualized in terms of emotional expressions that are delight, anger, sadness, and joy.

An information processing method according to Example 5 is the information processing method according to any one of Examples 1 to 3, wherein the plurality of emotional expression-related items may include sadness, anxiety, anger, disgust, trust, surprise, and joy.

Accordingly, the emotion of a person during communication can be visualized in terms of emotional expressions that are sadness, anxiety, anger, disgust, trust, surprise, and joy.

An information processing method according to Example 6 is the information processing method according to any one of Examples 1 to 3, wherein the plurality of emotional expression-related items may include delight, anger, excitement, sadness, fondness, fear, relief, dislike, surprise, and shame.

Accordingly, the emotion of a person during communication can be visualized in terms of emotional expressions that are delight, anger, excitement, sadness, fondness, fear, relief, dislike, surprise, and shame.

An information processing method according to Example 7 is the information processing method according to any one of Examples 1 to 6, wherein in the performing of the emotion analysis, similarity degrees between the plurality of words or phrases and the plurality of emotional expression-related items may be obtained and the analysis result of the emotion analysis may be derived based on the similarity degrees.

Thus, the analysis accuracy of emotion analysis can be improved by deriving an analysis result of the emotion analysis based on similarity degrees between a plurality of words or phrases and a plurality of emotional expressions.

An information processing method according to Example 8 is the information processing method according to any one of Examples 1 to 7, wherein in the performing of the emotion analysis, the analysis result of the emotion analysis may be derived by performing correspondence analysis.

Accordingly, the emotion of a person belonging to an organization during communication can be visualized so that the emotion can be understood immediately.

An information processing method according to Example 9 is the information processing method according to Example 8, wherein in the performing of the emotion analysis, the correspondence analysis may be performed by analyzing correlation between the plurality of words or phrases and the plurality of emotional expression-related items.

Accordingly, the emotion of a person belonging to an organization during communication can be visualized in a state where a plurality of emotional expressions have a relation.

An information processing method according to Example 10 is the information processing method according to any one of Examples 1 to 9, wherein the information related to communication by the person may be information expressed by the person in at least one of a meeting, an online chat, or an e-mail transmission.

Accordingly, text information can be obtained based on information expressed in at least one of an online meeting, a face-to-face meeting, a hybrid meeting, an online chat, or an e-mail transmission. Accordingly, the emotion of a person belonging to an organization during communication can be visualized.

An information processing method according to Example 11 is the information processing method according to any one of Examples 1 to 10 further including obtaining a keyword related to an interest and a concern of a viewer, wherein in the visualizing of the analysis result, the analysis result of the emotion analysis may be visualized after filtering using the keyword.

Accordingly, the emotion of a person belonging to an organization can be visualized in terms of a keyword related to an interest and a concern of a viewer.

An information processing system according to Example 12 includes: an information obtainer that obtains, as text information, information related to communication by a person; an emotion analyzer that performs emotion analysis on a plurality of words or phrases after breaking down the text information into the plurality of words or phrases by performing morphological analysis on the text information; and an emotion visualizer that visualizes an analysis result of the emotion analysis according to each row and column of a matrix table by forming the matrix table by arranging, in a first direction, a plurality of emotional expression-related items that represent human emotions and arranging, in a second direction, an attribute category-related item that indicates an attribute of the person or an organization.

Thus, the emotion of a person belonging to an organization during communication can be visualized by visualizing an analysis result of emotion analysis according to each row and column of a matrix table that is formed by emotional expression-related items and an attribute category-related item.

A recording medium according to Example 13 is a non-transitory computer-readable recording medium having recorded thereon a program for causing the computer to execute the information processing method according to any one of Examples 1 to 11.

Accordingly, the above-described information processing method can be executed by the computer in accordance with the program of the recording medium.

It should be noted that these general or specific aspects may be realized as a system, a device, a method, an integrated circuit, a computer program, or a non-transitory computer readable recording medium such as a CD-ROM, or any given combination thereof.

Hereinafter, an embodiment will be described with reference to the Drawings. It should be noted that the embodiment described below shows a general or specific example. The numerical values, shapes, materials, constituent elements, the arrangement and connection of the constituent elements, steps, the processing order of the steps etc. shown in the following embodiment are mere examples, and therefore do not limit the scope of the Claims.

### (Embodiment)

### [Configuration of Information Processing System]

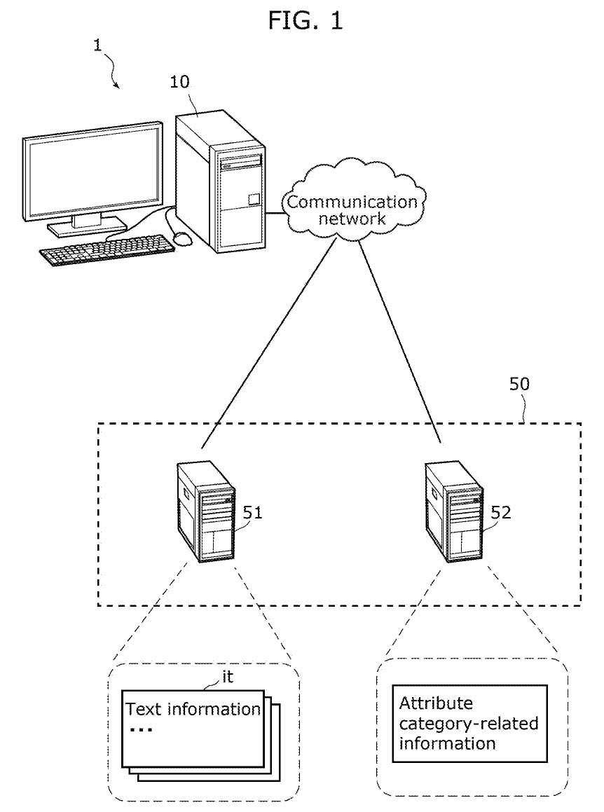

A configuration of an information processing system according to an embodiment will be described with reference to FIG. 1 to FIG. 6.

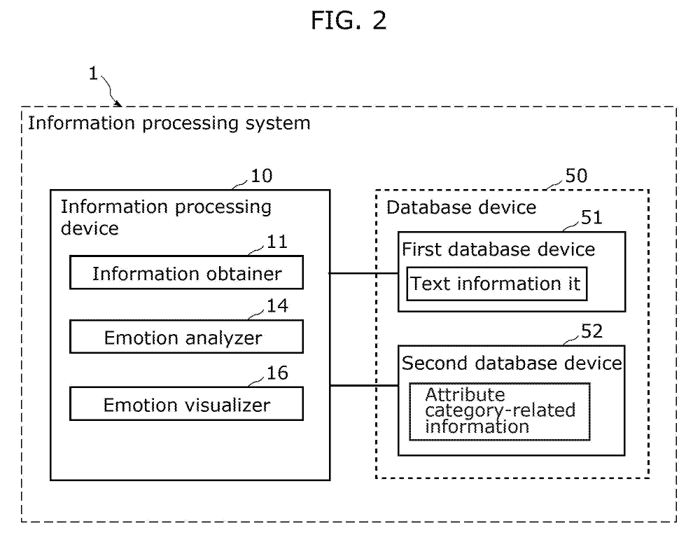

FIG. 1 is a schematic diagram illustrating information processing system 1 according to the embodiment. FIG. 2 illustrates a block configuration of information processing system 1 and information processing device 10 included in information processing system 1.

As illustrated in FIG. 1 and FIG. 2, information processing system 1 includes information processing device 10 and database device 50. Information processing device 10 and database device 50 are connected to each other via a communication network.

Information processing device 10 is a device that visualizes the emotion of a person belonging to an organization during communication.

It should be noted that an organization is a group of two or more persons, and a business organization and an association are typical examples of a modern organization. However, the present disclosure is not limited to these examples and an “organization” here also includes a consortium, community, or decentralized autonomous organization (DAO) that spans business organizations, public institutions, or associations, or the like.

For example, information processing device 10 is a computer device, receives and outputs various types of information, and performs calculation processing. Information processing device 10 accesses database device 50 to obtain necessary information.

For example, database device 50 is a computer device and receives, outputs, edits, and stores various types of information. It should be noted that database device 50 also includes an external storage device such as a network attached storage (NAS).

Database device 50 includes first database device 51 and second database device 52. For example, first database device 51 and second database device 52 are provided inside a facility that is managed by an organization such as a company.

First database device 51 stores information expressed by a person in the organization. The information expressed by the person is stored as, for example, a text file, an audio file, or an image file. The audio file or the image file may be stored in a state where the audio file or the image file has been converted into a text file. The text file may include text information accompanying video data.

Second database device 52 stores attribute category-related information that indicates an attribute of a person belonging to a predetermined organization or an attribute of an organization. An attribute of a person or organization is a property or feature of the person or organization, and is, for example, a group to which the person or organization belongs in an organization or a job position or employment type of the person in an organization. A group to which a person belongs is, for example, a research and development center, a research and development department, or a development section, and an organization is organized hierarchically by linking small groups to a larger group. A job position of a person is the position of a job in a workplace, such as executive, supervisor, and general employee. It should be noted that an attribute of a person is not limited to a group, a job position, and an employment type, and may be the number of years for which the person has belonged to a group.

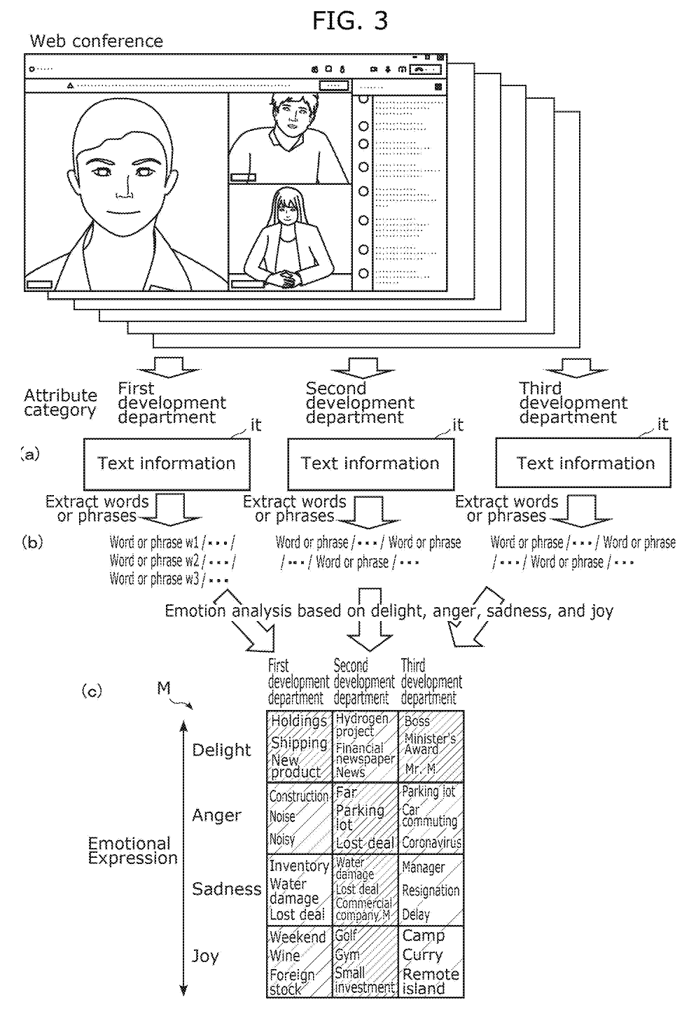

FIG. 3 illustrates an overview of processes performed by information processing system 1.

In (a) of FIG. 3, text information it that is information expressed by a person in a web conference is illustrated. In (b) of FIG. 3, an example in which a plurality of words or phrases w (w1, w2, w3, ...) are extracted from text information it is illustrated. In (c) of FIG. 3, an example in which emotion analysis is performed on the plurality of words or phrases w and an analysis result of the emotion analysis is shown in matrix table M is illustrated.

As illustrated in FIG. 3, information processing system 1 extracts a plurality of words or phrases w from text information it and performs emotion analysis on the plurality of words or phrases w. Moreover, information processing system 1 displays an analysis result of the emotion analysis according to each row and column of matrix table M that is formed by a plurality of emotional expressions and a plurality of attribute categories. According to information processing system 1, the emotion of a person belonging to an organization during communication can be visualized.

As illustrated in FIG. 2, information processing device 10 includes information obtainer 11, emotion analyzer 14, and emotion visualizer 16. Information obtainer 11, emotion analyzer 14, and emotion visualizer 16 are each a processing unit that is achieved by a program or a processor executing the program.

Information obtainer 11 is a processing circuit that obtains text information it. Information obtainer 11 obtains, as text information it, information related to communication by a person.

Information related to communication by a person is information expressed by the person in an organization. Information expressed by a person is information expressed by the person during communication between a plurality of persons including the person or communication between the person and an artificial object, and includes information spoken by the person and information documented by the person. For example, information related to communication by a person is information expressed by the person in at least one of a meeting, an online chat, or an e-mail transmission within an organization. It should be noted that, for example, when organization A is a target, information expressed by a person in a meeting is not limited to information expressed by a person in a meeting within organization A and includes information expressed by a member of organization A in an inter-organizational meeting between organization A and organization B (that is different from organization A). The same applies to an online chat and an e-mail transmission. Communication between a person and an artificial object includes a conversation (interaction) between a person and a machine (artificial object) such as an artificial intelligence (AI) chatbot or a conversational AI including Chat Generative Pre-trained Transformer (ChatGPT). Here, an “artificial object” is an AI chatbot or a conversational AI such as ChatGPT.

Information expressed by a person in an organization is stored as in-house intellectual property information in first database device 51 at any time. Text information it obtained by information obtainer 11 is outputted to emotion analyzer 14.

Emotion analyzer 14 is a processing circuit that performs emotion analysis based on text information it. First, emotion analyzer 14 performs morphological analysis on text information it to break down text information it into a plurality of words or phrases w, and obtains the plurality of words or phrases w (e.g., word or phrase w1, word or phrase w2, word or phrase w3, ...). Here, the plurality of words or phrases w are all words or phrases included in text information it.

The plurality of words or phrases w are also referred to as morphemes. A morpheme is the smallest unit of an expressive element that has a meaning. Morphological analysis is part of natural language processing and is a process of breaking down a sentence written in a natural language into the smallest units that each have a meaning in the language and determining, for each unit, its change, part of speech, or the like. By performing morphological analysis, a plurality of words or phrases w are extracted from text information it.

Emotion analyzer 14 performs emotion analysis based on the plurality of words or phrases w extracted by the morphological analysis. For example, emotion analyzer 14 obtains similarity degrees between the plurality of words or phrases w and a plurality of emotional expressions representing human emotions, and derives a result of the emotion analysis based on the similarity degrees. The plurality of emotional expressions are, for example, “delight, anger, sadness, and joy”.

The similarity degrees between the plurality of words or phrases w and the plurality of emotional expressions are each derived by a method using a cosine (cos) similarity. A cosine similarity is a numerical representation of how closely two vectors face in the same direction. Specifically, a cosine similarity is what represents an angle between two vectors as a cosine value, and can be calculated by using the inner product of the two vectors as a numerator and the magnitude of the two vectors as a denominator. For example, a similarity degree is low when a cosine similarity is 0, and a similarity degree is high when a cosine similarity is 1.

It should be noted that emotion analyzer 14 performs language conversion using word to vector (Word2vec) before calculating a similarity degree. Word2vec is a natural language processing method for converting a word in a sentence into a numerical vector to comprehend its meaning. For example, words that are used when performing emotion analysis by emotion analyzer 14 are a plurality of words or phrases w extracted from text information it and words representing a plurality of emotional expressions such as delight, anger, sadness, and joy. By performing conversion using Word2vec, calculation between two words that are a word in text information it and a word representing an emotional expression, specifically, calculation of a similarity degree is made possible.

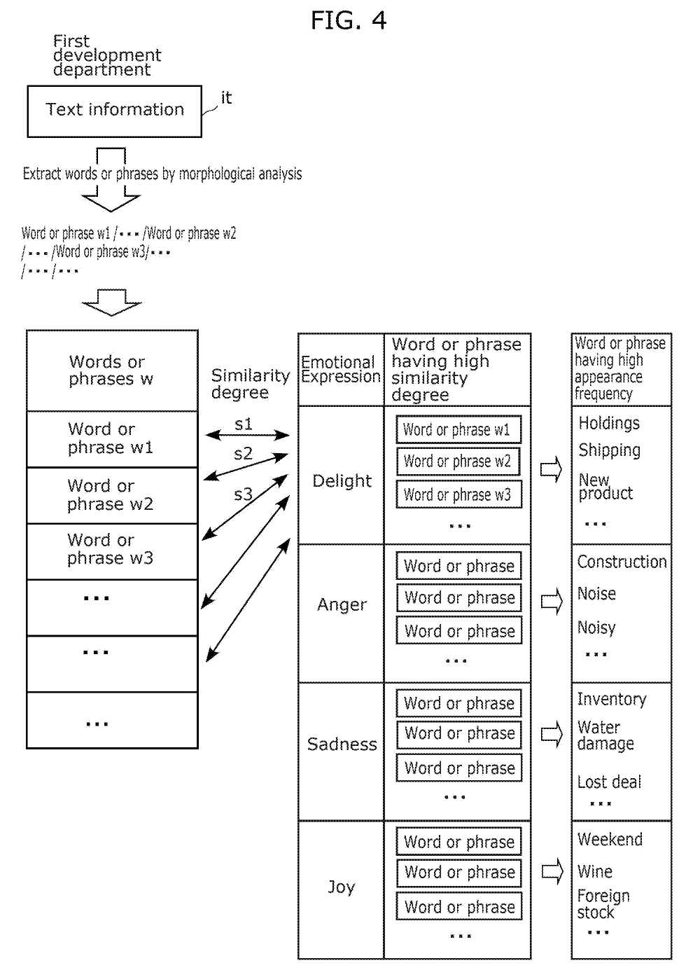

FIG. 4 illustrates an example of emotion analysis performed by information processing device 10.

Hereinafter, an example in which emotion analysis is performed on text information it of an organizational group called a first development department among a plurality of attribute categories will be described.

Emotion analyzer 14 categorizes a plurality of words or phrases w into a plurality of emotional expressions (delight, anger, sadness, and joy). Specifically, emotion analyzer 14 derives similarity degrees (s1, s2, s3, ...) between an emotional expression “delight” and the plurality of words or phrases w (w1, w2, w3, ...). Likewise, emotion analyzer 14 derives similarity degrees between an emotional expression “anger” and the plurality of words or phrases w (w1, w2, w3, ...), similarity degrees between an emotional expression “sadness” and the plurality of words or phrases w (w1, w2, w3, ...), and similarity degrees between an emotional expression “joy” and the plurality of words or phrases w (w1, w2, w3, ...).

Then, emotion analyzer 14 lists, for each of the plurality of emotional expressions, a plurality of words or phrases that each have a high similarity degree with the emotional expression. When listing a plurality of words or phrases that each have a high similarity degree, emotion analyzer 14 lists a plurality of words or phrases that each have a similarity degree of at least a predetermined threshold value. The predetermined threshold value is appropriately set within the range of at least 0.6 and at most 0.8, for example. The number of words or phrases listed up is set to at most 100 words or phrases in advance, for example. Accordingly, among the plurality of words or phrases w, a plurality of words or phrases each strongly representing an emotion represented by one of the plurality of emotional expressions are categorized into the emotional expression.

Moreover, for each of the plurality of emotional expressions, emotion analyzer 14 ranks the plurality of words or phrases that each have a high similarity degree with the emotional expression, according to their appearance frequency in text information it. FIG. 4 illustrates that “holdings, shipping, new product, ...” are the plurality of words or phrases that each have a high similarity degree with the emotional expression “delight” and are arranged in the order of appearance frequency in text information it. A word or phrase that has a high appearance frequency is a word or phrase that has a high probability of belonging to text information it.

Thus, emotion analyzer 14 derives a result of emotion analysis by obtaining similarity degrees between the plurality of words or phrases w and the plurality of emotional expressions. Emotion analysis is performed similarly for a second development department, a third development department, and the like that are development departments different from the first development department among the plurality of attribute categories.

It should be noted that the plurality of emotional expressions used in emotion analysis are not limited to “delight, anger, sadness, and joy” and may be ten types of emotions that are “delight, anger, excitement, sadness, fondness, fear, relief, dislike, surprise, and shame”. The plurality of emotional expressions may be seven emotions that are “sadness, anxiety, anger, disgust, trust, surprise, and joy” in the Japanese Inquiry and Word Count dictionary (JIWC-Dictionary). The plurality of emotional expressions may be expressions based on Russell's Circumplex Model of Emotion. The analysis result derived by emotion analyzer 14 is outputted to emotion visualizer 16.

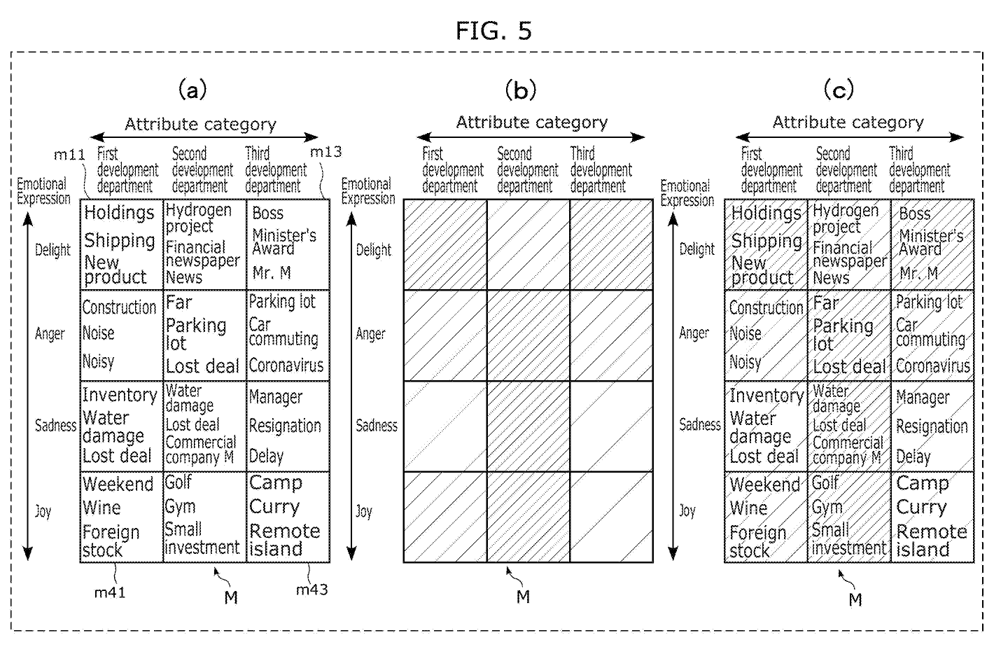

FIG. 5 illustrates an example of matrix table M used for visualizing a plurality of emotional expressions.

Emotion visualizer 16 is a processing circuit that visualizes an analysis result of emotion analysis. Emotion visualizer 16 visualizes an analysis result of emotion analysis using matrix table M.

Specifically, emotion visualizer 16 forms matrix table M by arranging, in a first direction, a plurality of emotional expression-related items that represent human emotions and arranging, in a second direction, an attribute category-related item that indicates an attribute of a person or an organization. It should be noted that the first direction and the second direction are directions that are orthogonal to each other and extend along a plane.

FIG. 5 illustrates an example in which matrix table M is formed by arranging a plurality of emotional expression-related items in a longitudinal direction (a direction in which rows are arranged) and arranging a plurality of attribute category-related items in a transverse direction (a direction in which columns are arranged). Matrix table M includes cells that are each denoted by mxy (where x and y are each an integer greater than or equal to 1 and identify a row and a column in the table, respectively). In the example, an analysis result of human emotions is visualized corresponding to each row and column of matrix table M including four rows and three columns.

The plurality of emotional expressions used in the emotion analysis performed by emotion analyzer 14 are used as the plurality of emotional expression-related items. FIG. 5 illustrates an example in which the plurality of emotional expression-related items are “delight, anger, sadness, and joy”. It should be noted that the plurality of emotional expression-related items may be ten emotions “delight, anger, excitement, sadness, fondness, fear, relief, dislike, surprise, and shame” or seven emotions “sadness, anxiety, anger, disgust, trust, surprise, and joy”, as long as they are the plurality of emotional expressions used in the emotion analysis performed by emotion analyzer 14.

The plurality of attribute categories used in the emotion analysis performed by emotion analyzer 14 are used as the plurality of attribute category-related items. FIG. 5 illustrates an example in which the plurality of attribute category-related items are “first development department, second development department, and third development department” that are groups to which persons belong. The plurality of attribute category-related items may be four or more groups such as “first development department, second development department, third development department, and fourth development department” or may be hierarchical groups such as “first development center, first development department, and first development section”, as long as they are the plurality of attribute categories used in the emotion analysis performed by emotion analyzer 14.

Moreover, although the plurality of emotional expression-related items are arranged in the longitudinal direction and the plurality of attribute category-related items are arranged in the transverse direction in the above-described example, the arrangement directions may be opposite to each other. Namely, the plurality of emotional expression-related items may be arranged in the transverse direction and the plurality of attribute category-related items may be arranged in the longitudinal direction. Although an example using a plurality of attribute category-related items has been described above, a single attribute category-related item may be used. Namely, it is sufficient if at least one attribute category-related item is arranged in the transverse direction.

Emotion visualizer 16 displays an analysis result of emotion analysis according to each row and column of matrix table M. In the present embodiment, emotion visualizer 16 visualizes human emotions using appearance frequency in text information it.

For example, as illustrated in (a) in FIG. 5, emotion visualizer 16 displays, in each row and column of matrix table M, a plurality of words or phrases that each have a high appearance frequency among the plurality of words or phrases w in text information it. (a) in FIG. 5 shows an example in which a plurality of words or phrases that each have a high appearance frequency and are related to the emotional expression “delight” in the attribute category “first development department” are “holdings, shipping, and new product”. More specifically, (a) in FIG. 5 shows an example in which, among a plurality of words or phrases that each have a high similarity degree with the emotional expression “delight”, a plurality of words or phrases that each have a high appearance frequency in text information it are “holdings, shipping, and new product” in the order of appearance frequency. In this example, in each row and column, a plurality of words or phrases are displayed so that the plurality of words or phrases are arranged in the order of appearance frequency from top to bottom. Although three words or phrases are displayed in each cell in (a) in FIG. 5, the present disclosure is not limited to this example and the number of words or phrases displayed in each cell may be at least one and at most five.

For example, as illustrated in (b) in FIG. 5, emotion visualizer 16 may display, in the rows and columns of matrix table M, frequency information that indicates appearance frequency levels of the plurality of words or phrases w in text information it. In (b) in FIG. 5, a heat map in which the frequency information is represented by the density of hatching lines is illustrated. For example, (b) in FIG. 5 illustrates that, in the attribute category “first development department”, the density of hatching lines for the emotional expression “delight” is higher than that for the emotional expressions “anger, sadness, and joy”, indicating that “first development department” expresses the emotion “delight” strongly.

Although the frequency information is indicated by three density levels of hatching lines in this example, the present disclosure is not limited to this example and frequency information may be indicated by four or more density levels of hatching lines. The frequency information may be indicated by color gradation or different colors such as red, green, and blue. The number of levels of frequency information may be set in advance using a threshold value, or determined based on relative evaluation of the rows and columns.

For example, as illustrated in (c) in FIG. 5, emotion visualizer 16 may display, in the rows and columns of matrix table M, both of: a plurality of words or phrases that each have a high appearance frequency among the plurality of words or phrases w in text information it; and frequency information that indicates appearance frequency levels of the plurality of words or phrases w in text information it. (c) in FIG. 5 corresponds to a combination of the display mode of (a) in FIG. 5 and the display mode of (b) in FIG. 5.

Emotion visualizer 16 outputs, to a computer or mobile terminal used by a user, the analysis result illustrated in FIG. 5. For example, emotion visualizer 16 uses application software to distribute an analysis result to a user registered in advance.

As described above, information processing system 1 according to the present embodiment includes: information obtainer 11 that obtains, as text information it, information related to communication by a person; emotion analyzer 14 that performs emotion analysis on a plurality of words or phrases w after breaking down text information it into the plurality of words or phrases w by performing morphological analysis on text information it; and emotion visualizer 16 that visualizes an analysis result of the emotion analysis according to each row and column of matrix table M by forming matrix table M by arranging, in a first direction, a plurality of emotional expression-related items that represent human emotions and arranging, in a second direction, an attribute category-related item that indicates an attribute of the person or an organization.

Thus, the emotion of a person belonging to an organization during communication can be visualized by visualizing an analysis result of emotion analysis according to each row and column of matrix table M that is formed by a plurality of emotional expression-related items and an attribute category-related item.

It should be noted that emotion analyzer 14 may derive an analysis result of emotion analysis by further performing correspondence analysis that analyzes bivariate correlation between a plurality of words or phrases w and a plurality of emotional expressions. The correspondence analysis is an analysis method for facilitating interpretation of an examination result by visualizing a cross-tabulation table, and is also referred to as CA. By performing correspondence analysis, emotion analyzer 14 rearranges the rows and columns in matrix table M so that the correlation between the row items and the column items is maximized.

For example, emotion analyzer 14 rearranges, based on the data in each row and column of matrix table M, the order of the row items or the order of the column items so that two items strongly correlated with each other are arranged next to each other. In the example illustrated in FIG. 5, the row items “delight, anger, sadness, and joy” are arranged in the stated order and the column items “first development department, second development department, and third development department” are arranged in the stated order. However, when the correlation between joy and delight is stronger than that between other row items and the correlation between third development department and first development department is stronger than that between other column items, the row items may be rearranged to “joy, delight, anger, and sadness” and the column items may be rearranged to “third development department, first development department, and second development department”. Accordingly, visualization in a state where a plurality of emotional expressions have a relation becomes possible.

### [Another Example of Visualization]

Another example of visualization by emotion visualizer 16 will be described. Hereinafter, an example in which a result of emotion analysis performed on text information it based on job positions such as executive, supervisor, and general employee among a plurality of attribute categories is visualized will be described. It should be noted that description regarding emotion analysis is omitted since emotion analysis performed on text information it based on job positions can be performed in the same way as the above-described emotion analysis performed on text information it based on organizational groups.

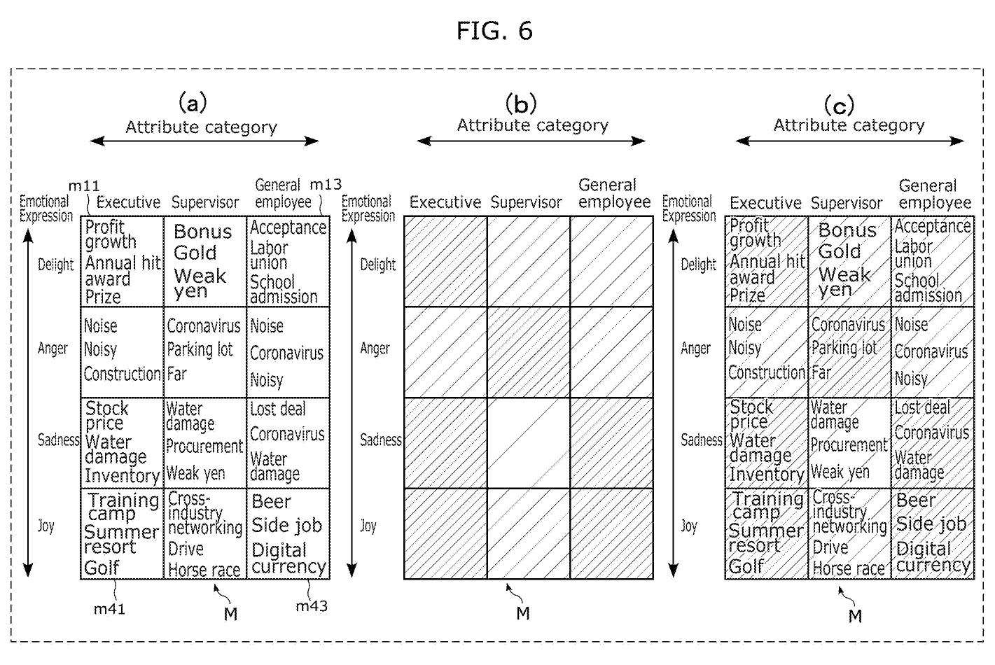

FIG. 6 illustrates another example of matrix table M.

The plurality of emotional expression-related items in matrix table M illustrated in FIG. 6 are the same as that in matrix table M illustrated in FIG. 5, and the plurality of attribute category-related items in matrix table M illustrated in FIG. 6 are different from that in matrix table M illustrated in FIG. 5.

The plurality of attribute categories used in the emotion analysis performed by emotion analyzer 14 are used as the plurality of attribute category-related items. FIG. 6 illustrates an example in which the plurality of attribute category-related items are the job positions of persons such as “executive, supervisor, and general employee”. The plurality of attribute category-related items may be four or more job positions such as “manager, section manager, team leader, and senior staff” as long as the plurality of attribute category-related items are the plurality of attribute categories used in the emotion analysis performed by emotion analyzer 14. The plurality of attribute category-related items may be employment types such as “full-time employee, temporary employee, and part-time worker”.

Emotion visualizer 16 displays an analysis result of emotion analysis according to each row and column of matrix table M. Here, an example in which emotion visualizer 16 visualizes human emotions by using appearance frequency in text information it will be described.

For example, as illustrated in (a) in FIG. 6, emotion visualizer 16 displays, in each row and column of matrix table M, a plurality of words or phrases that each have a high appearance frequency among the plurality of words or phrases w in text information it. (a) in FIG. 6 shows an example in which a plurality of words or phrases that each have a high appearance frequency and are related to the emotional expression “delight” in the attribute category “executive” are “profit growth, annual hit award, and prize”. More specifically, (a) in FIG. 6 shows an example in which, among a plurality of words or phrases that each have a high similarity degree with the emotional expression “delight”, a plurality of words or phrases that each have a high appearance frequency in text information it are “profit growth, annual hit award, and prize” in the order of appearance frequency. In this example, in each row and column, a plurality of words or phrases are displayed so that the plurality of words or phrases are arranged in the order of probability of belonging to text information it from top to bottom. Although three words or phrases are displayed in each cell in (a) in FIG. 6, the present disclosure is not limited to this example and the number of words or phrases displayed in each cell may be at least one and at most five.

For example, as illustrated in (b) in FIG. 6, emotion visualizer 16 may display, in the rows and columns of matrix table M, frequency information that indicates appearance frequency levels of the plurality of words or phrases w in text information it. In (b) in FIG. 6, a heat map in which frequency information is represented by the density of hatching lines is illustrated. For example, (b) in FIG. 6 illustrates that, in the attribute category “executive”, the density of hatching lines for the emotional expressions “delight, sadness, and joy” is high than that for the emotional expression “anger”, indicating that “executive” expresses the emotions “delight, sadness, and joy” strongly.

Although the frequency information is indicated by three density levels of hatching lines in this example, the present disclosure is not limited to this example and frequency information may be indicated by four or more density levels of hatching lines. The frequency information may be indicated by color gradation or different colors such as red, green, and blue. The number of levels of frequency information may be set in advance using a threshold value, or determined based on relative evaluation of the rows and columns.

For example, as illustrated in (c) in FIG. 6, emotion visualizer 16 may display, in the rows and columns of matrix table M, both of: a plurality of words or phrases that each have a high appearance frequency among the plurality of words or phrases w in text information it; and frequency information that indicates appearance frequency levels of the plurality of words or phrases w in text information it.

Emotion visualizer 16 outputs, to a computer or mobile terminal used by a user, the analysis result illustrated in FIG. 6. For example, emotion visualizer 16 uses application software to distribute an analysis result to a user registered in advance.

### [Information Processing Method]

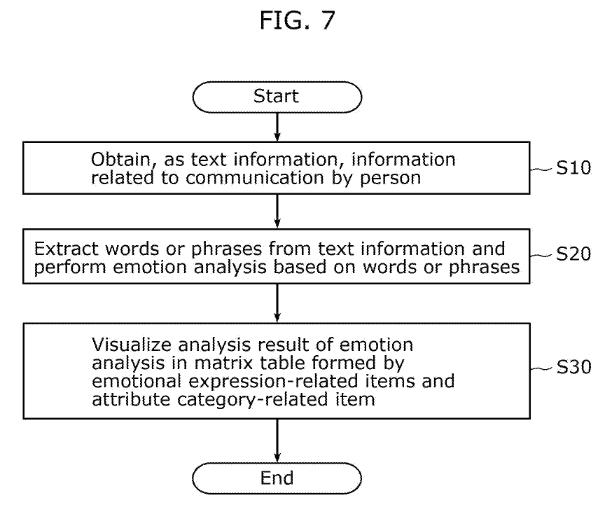

An information processing method according to the embodiment will be described with reference to FIG. 7.

FIG. 7 is a flowchart illustrating an information processing method according to the embodiment.

First, information processing device 10 obtains, as text information it, information related to communication by a person (step S10). For example, information processing device 10 accesses first database device 51 to obtain text information it.

The information related to communication by a person that is the origin of text information it is information expressed by the person during communication between a plurality of persons including the person or communication between the person and an artificial object. For example, the information related to communication by a person is information expressed by the person in at least one of a meeting, an online chat, or an e-mail transmission.

Next, information processing device 10 extracts a plurality of words or phrases w from text information it and performs emotion analysis based on the plurality of words or phrases w (step S20). For example, information processing device 10 performs morphological analysis on text information it to break down text information it into a plurality of words or phrases w, and extracts the plurality of words or phrases w. Moreover, information processing device 10 obtains similarity degrees between the plurality of words or phrases w and a plurality of emotional expressions, and derives a result of emotion analysis based on the similarity degrees.

It should be noted that information processing device 10 may derive an analysis result of emotion analysis by performing correspondence analysis in step S20. In this case, information processing device 10 may perform correspondence analysis by analyzing bivariate correlation between the plurality of words or phrases w and the plurality of emotional expressions in step S20.

Next, information processing device 10 visualizes the analysis result of the emotion analysis in matrix table M formed by a plurality of emotional expression-related items and an attribute category-related item (step S30). Specifically, information processing device 10 forms matrix table M by arranging, in a first direction, a plurality of emotional expression-related items that represent human emotions and arranging, in a second direction, an attribute category-related item that indicates an attribute of the person or an organization.

The attribute category-related item arranged in the second direction is an item that is related to a group to which the person belongs or an item that is related to a job position or employment type of the person. Information processing device 10 accesses second database device 52 to obtain attribute category-related information.

The plurality of emotional expression-related items arranged in the first direction include delight, anger, sadness, and joy. It should be noted that the plurality of emotional expression-related items may be items that include sadness, anxiety, anger, disgust, trust, surprise, and joy. The plurality of emotional expression-related items may be items that include delight, anger, excitement, sadness, fondness, fear, relief, dislike, surprise, and shame.

Information processing device 10 visualizes an analysis result of emotion analysis according to each row and column of matrix table M. Information processing device 10 visualizes, as the analysis result, at least one of: a word or phrase that has a high appearance frequency among the plurality of words or phrases w in text information it; or frequency information that indicates appearance frequency levels of the plurality of words or phrases w in text information it. Information processing device 10 outputs the analysis result to a computer or mobile terminal used by a user.

An analysis result of emotion analysis is visualized by performing steps S10 to S30. According to the information processing method, the emotion of a person belonging to an organization during communication can be visualized.

It should be noted that the information processing method according to the embodiment may further include obtaining a keyword related to an interest and a concern of a viewer. In this case, information processing device 10 obtains a keyword related to an interest and a concern of a viewer through a user interface provided to information processing device 10. Then, in step S30 for visualizing an analysis result of emotion analysis, information processing device 10 visualizes an analysis result of emotion analysis after filtering using the keyword.

### (Other Embodiments)

Although an aspect of an information processing system or the like has been described according to the embodiment, the aspect of the information processing system or the like is not limited to the embodiment. Modifications conceivable by those skilled in the art may be made to the embodiment and the constituent elements in the embodiment may be arbitrarily combined.

Although an example in which a plurality of words or phrases w are extracted by performing morphological analysis on text information it has been described in the above-described embodiment, the present disclosure is not limited to this example. For example, emotion analyzer 14 may extract a plurality of topics from text information it by analyzing text information it using topic modeling that is an example of Latent Semantic Analysis. Topic modeling is a natural language processing method of classifying a plurality of items of text information into categories based on the content included in each of the plurality of items of the text information, interpreting the meaning of each word present in the plurality of items of the text information in terms of the category classified, and extracting a topic from the plurality of items of the text information. A topic is a latent semantic category, is called a “latent topic” or simply a “topic”, and is a term that concisely and comprehensively represents semantic content indicated by a plurality of words. A topic may be a word present in text information or a term formed by compounding and processing a plurality of words present in text information. By performing topic modeling, the latent meaning of a document can be understood treating, as a single topic, a plurality of words that mean the same content.

Moreover, for example, a process performed by a particular constituent element in the embodiment may be performed by a different constituent element instead of the particular constituent element. Furthermore, the processing order of a plurality of processes may be changed, and a plurality of processes may be performed in parallel. Furthermore, ordinal numbers such as first and second used for description of the embodiment may be appropriately exchanged, removed, or newly added. These ordinal numbers do not necessarily correspond to significant order, and may be used to distinguish between elements.

The information processing method may be executed by an optional system or an optional device. In other words, the information processing method may be executed by the above-described information processing system or the like, or may be executed by other systems or devices.

For example, part or all of the information processing method may be executed by a computer that includes a processor, a memory, an input/output circuit, or the like. In this case, the information processing method may be executed by the computer executing a program for causing the computer to execute the information processing method.

Moreover, the above-described program may be recorded on a non-transitory computer-readable recording medium such as a CD-ROM.

Furthermore, each of the constituent elements included in the information processing system or the like may be configured as a dedicated hardware product, a general-purpose hardware product that executes the above-described program, or a combination thereof. Furthermore, the general-purpose hardware product may include: a memory on which a program is recorded; a general-purpose processor that executes the program by reading out the program from the memory; or the like. Here, the memory may be a semiconductor memory, a hard disk, or the like, and the general-purpose processor may be a central processing unit (CPU) or the like.

Moreover, the dedicated hardware product may include a memory, a dedicated processor, or the like. For example, the dedicated processor may execute the above-described information processing method by referring to the memory.

### INDUSTRIAL APPLICABILITY

Moreover, each of the constituent elements included in the information processing system may be an electric circuit. These electric circuits may constitute a single circuit as a whole or may be individual circuits. Moreover, these electric circuits may be compatible with a dedicated hardware product or a general-purpose hardware product that executes the above-described program or the like.

The present disclosure is applicable to a communication information visualization device or the like that visualizes the emotion of a person during communication.

1. An information processing method that is performed by a
computer, the information processing method comprising:
obtaining, as text information, information related to communication by a person;
performing emotion analysis on a plurality of words or phrases after breaking down the text information into the plurality of words or phrases by performing morphological analysis on the text information; and
visualizing an analysis result of the emotion analysis according to each row and column of a matrix table by forming the matrix table by arranging, in a first direction, a plurality of emotional expression-related items that represent human emotions and arranging, in a second direction, an attribute category-related item that indicates an attribute of the person or an organization.

2. The information processing method according to claim 1,wherein
in the visualizing of the analysis result, at least one of the following is visualized as the analysis result: a word or phrase that has a high appearance frequency among the plurality of words or phrases in the text information; or frequency information that indicates appearance frequency levels of the plurality of words or phrases in the text information.

3. The information processing method according to claim 1, wherein
the attribute category-related item is an item that is related to a group to which the person belongs or an item that is related to a job position or employment type of the person.

4. The information processing method according to claim 1,wherein
the plurality of emotional expression-related items include delight, anger, sadness, and joy.

5. The information processing method according to claim 1,wherein
the plurality of emotional expression-related items include sadness, anxiety, anger, disgust, trust, surprise, and joy.

6. The information processing method according to claim 1, wherein
the plurality of emotional expression-related items include delight, anger, excitement, sadness, fondness, fear, relief, dislike, surprise, and shame.

7. The information processing method according to claim 4, wherein
in the performing of the emotion analysis, similarity degrees between the plurality of words or phrases and the plurality of emotional expression-related items are obtained and the analysis result of the emotion analysis is derived based on the similarity degrees.

8. The information processing method according to claim 1, wherein
in the performing of the emotion analysis, the analysis result of the emotion analysis is derived by performing correspondence analysis.

9. The information processing method according to claim 8, wherein
in the performing of the emotion analysis, the correspondence analysis is performed by analyzing correlation between the plurality of words or phrases and the plurality of emotional expression-related items.

10. The information processing method according to claim 1, wherein
the information related to communication by the person is information expressed by the person in at least one of a meeting, an online chat, or an e-mail transmission.

11. The information processing method according to claim 1, further comprising:
obtaining a keyword related to an interest and a concern of a viewer, wherein
in the visualizing of the analysis result, the analysis result of the emotion analysis is visualized after filtering using the keyword.

12. An information processing system comprising:
an information obtainer that obtains, as text information, information related to communication by a person;
an emotion analyzer that performs emotion analysis on a plurality of words or phrases after breaking down the text information into the plurality of words or phrases by performing morphological analysis on the text information; and
an emotion visualizer that visualizes an analysis result of the emotion analysis according to each row and column of a matrix table by forming the matrix table by arranging, in a first direction, a plurality of emotional expression-related items that represent human emotions and arranging, in a second direction, an attribute category-related item that indicates an attribute of the person or an organization.

13. A non-transitory computer-readable recording medium having recorded thereon a program for causing a computer to execute the information processing method according to claim 1.
